(19) United States
(12) Patent Application Publication
(10) Pub. No.: US 2024/0219210 A1
(43) Pub. Date: Jul. 4, 2024

(54) CAPACITIVE SENSOR

(71) Applicant: Alps Alpine Co., Ltd., Tokyo (JP)

(72) Inventor: Akihisa IIKURA, Miyagi-ken (JP)

(21) Appl. No.: 18/604,095

(22) Filed: Mar. 13, 2024

Related U.S. Application Data
(63) Continuation of application No. PCT/JP2022/009213, filed on Mar. 3, 2022.

(30) Foreign Application Priority Data
Sep. 30, 2021 (JP) 2021-161423

(51) Int. Cl. G01D 5/241; G06F 3/041; G06F 3/044

(52) U.S. Cl. CPC G01D 5/241; G06F 3/04166; G06F 3/0418; G06F 3/0447; G06F 2203/04107

(57) ABSTRACT

A capacitive sensor includes: front-side electrodes including a detection electrode; a cover that covers the front-side electrodes; an elastic dielectric body below the front-side electrodes; a shield electrode below the elastic dielectric body; a first voltage output unit that outputs a first alternating-current voltage to a driving unit coupled to the detection electrode; a second voltage output unit that outputs, to the shield electrode, a second alternating-current voltage having the same phase as the first alternating-current voltage; a detection unit connected to the detection electrode, the detection unit detecting an output matching capacitances among the front-side electrodes; and an operation decision unit that decides whether the cover has been pressed with a detection target, according to a plurality of outputs from the detection unit, the plurality of outputs being obtained when the second voltage output unit changes the amplitude of the second alternating-current voltage to a plurality of amplitudes.

### CLAIM OF PRIORITY

This application is a Continuation of International Application No. PCT/JP2022/009213 filed on Mar. 3, 2022, which claims benefit of Japanese Patent Application No. 2021-161423 filed on Sep. 30, 2021. The entire contents of each application noted above are hereby incorporated by reference.

### BACKGROUND OF THE INVENTION

### 1. Field of the Invention

The present invention relates to a capacitive sensor.

### 2. Description of the Related Art

A conventional display device that has: a light-emitting element layer; a plurality of first electrodes, each of which extends in a first direction and each two of which are adjacent to each other in a second direction crossing the first direction; a plurality of second electrodes, each of which extends in the second direction above the plurality of first electrodes and each two of which are adjacent to each other in the first direction; insulating elastic layers interposed to secure spacings between the plurality of first electrodes and the plurality of second electrodes; and a sensing circuit.

The sensing circuit measures a first physical quantity corresponding to a first capacitance parasitic to each of electrode groups composed of the plurality of first electrodes and the plurality of second electrodes, and detects that when an obtained first measurement value is outside a first range, a significant change has occurred in the first capacitance due to the proximity of a conductor, examples of which include a finger. Furthermore, the sensing circuit measures a second physical quantity corresponding to a second capacitance between each of the plurality of first electrodes and each of the plurality of second electrodes, and detects that when an obtained second measurement value is outside a second range, a significant change has occurred in the second capacitance due to the compression of the insulating elastic layer with a pressing force (see the description in U.S. Pat. No. 10,429,984B2, for example).

With the conventional display device, however, both the first capacitance and the second capacitance are affected by both of the proximity of a finger and pressing with it, so it is not possible to accurately measure that pressing has been performed.

### SUMMARY OF THE INVENTION

In view of this, the present invention provides a capacitive sensor that can accurately detect that pressing with a detection target has been performed.

A capacitive sensor of the present invention includes: one or a plurality of front-side electrodes including one or more detection electrodes; a cover placed on the front side of the one or plurality of front-side electrodes; an elastic dielectric body disposed on the back side of the one or plurality of front-side electrodes; a shield electrode disposed on the back side of the elastic dielectric body; a first voltage output unit that outputs a first alternating-current voltage to a driving unit coupled to the one or more detection electrodes with capacitances interposed between the driving unit and the one or more detection electrodes; a second voltage output unit that outputs, to the shield electrode, a second alternating-current voltage having the same phase as the first alternating-current voltage; a detection unit connected to the one or more detection electrodes, the detection unit detecting an output matching capacitances among the one or plurality of front-side electrodes; and an operation decision unit that makes a decision about the motion of a detection target according to the output from the detection unit. The second voltage output unit is configured to change the amplitude of the second alternating-current voltage. The operation decision unit decides that pressing with the detection target against the cover has been performed, according to a plurality of outputs from the detection unit, the plurality of outputs being obtained when the second voltage output unit changes the amplitude of the second alternating-current voltage to a plurality of amplitudes.

It is possible to provide a capacitive sensor that can accurately detect that pressing with a detection target has been performed.

### BRIEF DESCRIPTION OF THE DRAWINGS

FIG. 1 illustrates the planar structure of a capacitive sensor in embodiment 1;

FIG. 2 illustrates the sectional structure of part of the capacitive sensor;

FIG. 3 illustrates an equivalent circuit of the capacitive sensor;

FIG. 4 illustrates examples of the waveforms of alternating-current voltages;

FIGS. 5A to 5C illustrate time-varying changes in capacitances and output voltages in the capacitive sensor;

FIG. 6 illustrates a capacitive sensor in embodiment 2; and

FIG. 7 illustrates a capacitive sensor in embodiment 3.

### DESCRIPTION OF THE PREFERRED EMBODIMENTS

Embodiments to which a capacitive sensor in the present invention is applied will be described below.

### Embodiment 1

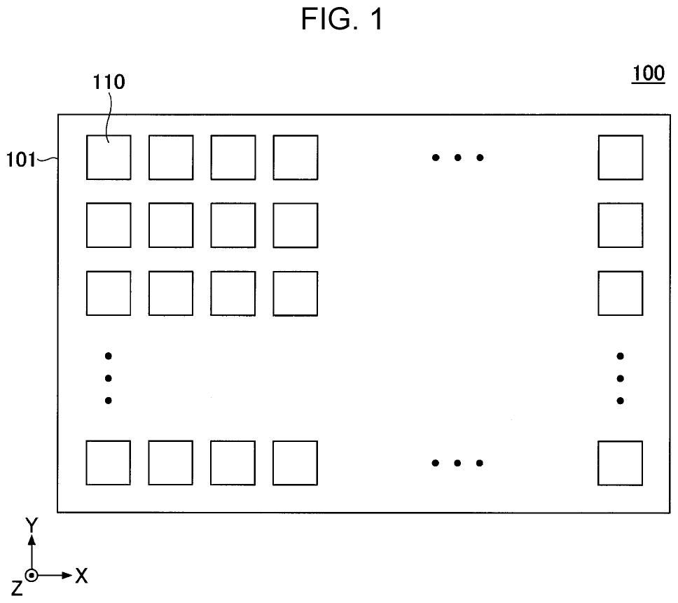

FIG. 1 illustrates the planar structure of a capacitive sensor 100 in embodiment 1. The description below is based on an XYZ coordinate system. A direction parallel to the X axis is an X direction. A direction parallel to the Y axis is a Y direction. A direction parallel to the Z axis is a Z direction. These directions are mutually orthogonal. In the description below, the −Z-direction side may be referred to as the lower side or bottom, and the +Z-direction side may be referred to as the upper side or top, for convenience of explanation. However, these directions do not represent a universal up-down relationship. The upper surface side of a certain constituent element is a front side, and its lower surface side is a back side. The phrase “in plan view” will refer to an XY plane being viewed. In the description below, for easy understanding of the structure, the length, bulkiness, thickness, and the like of each portion may be indicated by being exaggerated.

The capacitive sensor 100 includes a cover 101 and a plurality of front-side electrodes 110. The cover 101 is placed on the front side of the plurality of front-side electrodes 110. In addition to them, the capacitive sensor 100 includes an operation decision unit and the like, the operation decision unit deciding that any one operation of a proximity of, a contact of, and pressing with a fingertip of the user or the like for the cover 101 has been performed. In FIG. 1, however, the operation decision unit and the like are omitted and only the planar structure of the cover 101 and the plurality of front-side electrodes 110 is indicated.

As an example, the cover 101 is a plate-like member that is made of transparent glass or a resin and has a rectangular shape in plan view, the member being capable of warping when the upper surface of the cover 101 is pressed from above, the upper surface being a manipulation surface on which the user performs a manipulation input by touching the upper surface with a fingertip or the like. The user can also press the upper surface of the cover 101 downward. The cover 101 is provided as a top panel that covers the upper surface of the capacitive sensor 100.

The plurality of front-side electrodes 110 are placed below the lower surface of the cover 101 and are arranged in a matrix in the X direction and Y direction. The plurality of front-side electrodes 110 are mutually independent as an example, and are connected to a detection unit, which will be described later, and the like through wires (not illustrated) routed among the front-side electrodes 110 in plan view.

In FIG. 1, the plurality of front-side electrodes 110 are illustrated as being transparent. The plurality of front-side electrodes 110 are composed of transparent electrodes formed from such as, for example, an indium tin oxide (ITO) material. An aspect will be described here in which the cover 101 and the plurality of front-side electrodes 110 are transparent, assuming that a display panel, such as a liquid crystal display or an organic electroluminescence (EL) display, is placed below the capacitive sensor 100. However, if a display panel is not placed, for example, the cover 101 and the plurality of front-side electrodes 110 may not be transparent and only need to be made of a material having conductivity. In this case, the plurality of front-side electrodes 110 may be metal plates or the like.

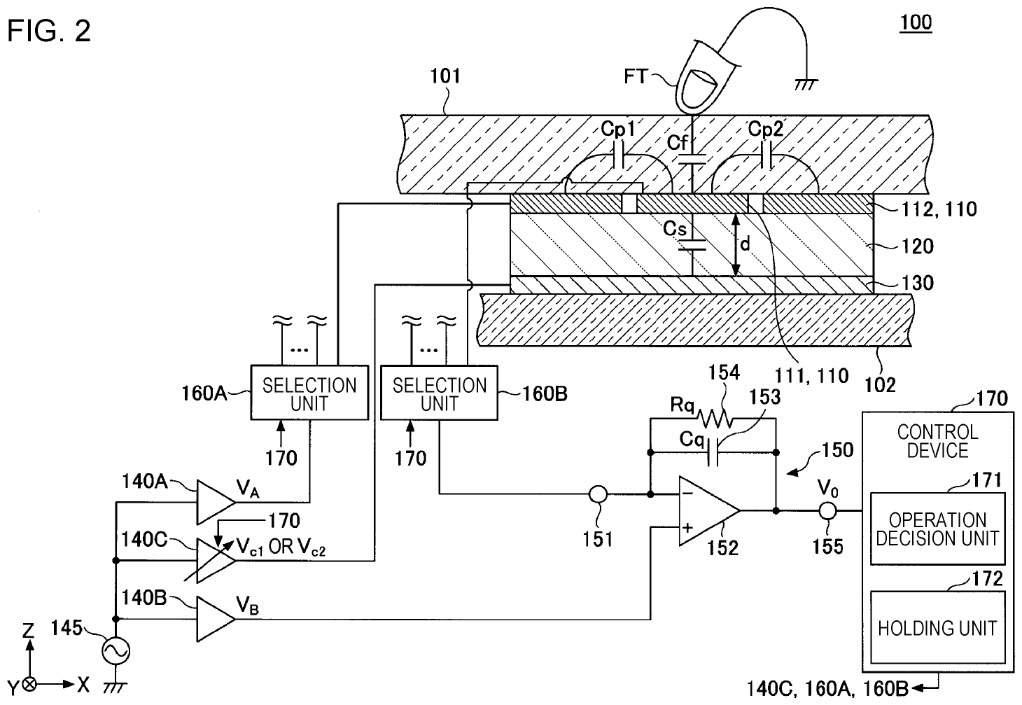

FIG. 2 illustrates the sectional structure of part of the capacitive sensor 100. Specifically, FIG. 2 illustrates the sectional structure of a portion at which three front-side electrodes 110 are arranged in the X direction. An aspect will be described here as an example in which the user performs a manipulation input on the capacitive sensor 100 with a fingertip FT. The fingertip FT is an example of a detection target. When performing a manipulation input, the user touches the cover 101 with the fingertip FT (brings the fingertip FT into contact with the cover 101).

Besides the cover 101 and front-side electrodes 110, the capacitive sensor 100 further includes an elastic dielectric body 120, a shield electrode 130, an amplification circuit 140A, an amplification circuit 140B, a variable amplification circuit 140C, a power supply circuit 145, a detection unit 150, selection units 160A and 160B, and a control device 170. The power supply circuit 145 is an alternating-current voltage source that outputs an alternating-current voltage in a sinusoidal wave having a predetermined amplitude. The power supply circuit 145 outputs an alternating-current voltage to the amplification circuit 140A, amplification circuit 140B, and variable amplification circuit 140C. A combination of the amplification circuit 140A and power supply circuit 145 is an example of a first voltage output unit. A combination of the amplification circuit 140B and power supply circuit 145 is an example of a third voltage output unit. A combination of the variable amplification circuit 140C and power supply circuit 145 is an example of a second voltage output unit. The control device 170 includes an operation decision unit 171 and a holding unit 172. The capacitive sensor 100 further includes a substrate 102.

As an example, the selection unit 160A selects two front-side electrodes 110 from the plurality of front-side electrodes 110 as the connection destinations of the amplification circuit 140A. As an example, the selection unit 160B also selects one front-side electrode 110 from the plurality of front-side electrodes 110 as the connection destination of the amplification circuit 140B and detection unit 150. It will be assumed here that the selection unit 160B has selected the front-side electrode 110 at the center of the three front-side electrodes 110 illustrated in FIG. 2 and has connected the front-side electrode 110 to the amplification circuit 140B and detection unit 150. It will be also assumed that the selection unit 160A has selected two front-side electrodes 110 at both ends of the three front-side electrodes 110 illustrated in FIG. 2 and has connected the front-side electrodes 110 to the amplification circuit 140A.

Of the three front-side electrodes 110 illustrated in FIG. 2, the front-side electrode 110 at the center is a detection electrode 111 and the remaining two front-side electrodes 110 at both ends of the detection electrodes 111 are driving electrodes 112. The driving electrode 112 is an example of a driving unit. Therefore, the reference numeral 110 is illustrated in parentheses for the detection electrode 111 and driving electrode 112.

The detection electrode 111 is a front-side electrode 110, of the plurality of front-side electrodes 110, that is selected by the selection unit 160B and is connected to the amplification circuit 140B and detection unit 150. Each driving electrode 112 is a front-side electrode 110, of the plurality of front-side electrodes 110, that is selected by the selection unit 160A and is connected to the amplification circuit 140A. In the description below, the front-side electrode 110 will be referred to when the detection electrode 111 and driving electrode 112 are not particularly distinguished from each other and when a front-side electrode 110 other than the detection electrode 111 and driving electrode 112 is described.

The detection electrode 111 is used to detect a proximity of, a contact of, and pressing with the fingertip FT of the user for the cover 101. The capacitive sensor 100 detects a proximity of, a contact of, and pressing with the fingertip FT by sequentially selecting the plurality of front-side electrodes 110 one by one as the detection electrode 111 through the selection unit 160B and then detecting a capacitance. At this time, an alternating-current voltage V_{B}, resulting from amplifying, in the amplification circuit 140B, an output supplied from the power supply circuit 145, is applied to the detection electrode 111 through the detection unit 150. The alternating-current voltage V_{B} is an example of a third alternating-current voltage. When the operation decision unit 171 decides that a contact or pressing has been performed at the detection electrode 111 selected by the selection unit 160B, this indicates that a manipulation input has been performed at the position (coordinates) corresponding to that detection electrode 111.

Although an aspect will be described here in which the plurality of front-side electrodes 110 are sequentially selected one by one as the detection electrode 111, the selection unit 160B may concurrently select two or more front-side electrodes 110 that are not adjacent to each other as detection electrodes 111 to concurrently detect a proximity of, a contact of, and pressing with the fingertip FT at two or more detection electrodes 111. To do this, the plurality of front-side electrodes 110 include one or more detection electrodes 111.

The driving electrodes 112 are front-side electrodes 110 positioned on both sides of the detection electrode 111 in the X direction. When the capacitive sensor 100 sequentially selects the plurality of front-side electrodes 110 one by one as the detection electrode 111 through the selection unit 160B, the capacitive sensor 100 selects two front-side electrodes 110 positioned on both sides of the detection electrode 111 in the X direction as two driving electrodes 112 through the selection unit 160A.

When a proximity of, a contact of, and pressing with the fingertip FT are to be detected with the detection electrode 111, an alternating-current voltage V_{A}, resulting from amplifying, in the amplification circuit 140A, an output supplied from the power supply circuit 145, is applied to the driving electrodes 112. The alternating-current voltage V_{A} is an example of a first alternating-current voltage having an amplitude of V_{A} (V). Although an aspect will be described here in which two front-side electrodes 110 positioned next to both sides of the detection electrode 111 in the X direction are taken as the driving electrodes 112, a total of four front-side electrodes 110 may be taken as driving electrodes 112, the four front-side electrodes 110 being two front-side electrodes 110 positioned next to both sides of the detection electrode 111 in the X direction and two front-side electrodes 110 positioned next to both sides of the detection electrode 111 in the Y direction.

When the front-side electrode 110 positioned at an end in the −X direction, for example, is used as the detection electrode 111, two front-side electrodes 110 positioned next to both sides of the detection electrode 111 in the Y direction may be used as the two driving electrodes 112. Alternatively, the front-side electrode 110 next to the detection electrode 111 in the +X direction and the front-side electrode 110 next to the detection electrode 111 in the −Y direction or +Y direction may be used as the two driving electrodes 112. When the front-side electrode 110 positioned at a corner of the plurality of front-side electrodes 110 arranged in a matrix is used as the detection electrode 111, it suffices to use the front-side electrode 110 next to the detection electrode 111 in the X direction and the front-side electrode 110 next to the detection electrode 111 in the Y direction as two driving electrodes 112.

The elastic dielectric body 120 is disposed on the back side of, that is, below, a plurality of front-side electrodes 110 (see FIGS. 1 and 2). The elastic dielectric body 120 is transparent. It can be elastically deformed. The elastic dielectric body 120 is formed from, for example, a urethane resin. The elastic dielectric body 120 is disposed at a position at which it overlaps all of the plurality of front-side electrodes 110 in plan view. The thickness of the elastic dielectric body 120 in the Z direction is uniform. Since the elastic dielectric body 120 can be elastically deformed, when the user presses a portion immediately above the relevant detection electrode 111 in the downward direction, the portion being part of the upper surface of the cover 101, with the fingertip FT, the elastic dielectric body 120 warps and contracts, so the detection electrode 111 is slightly displaced downward.

The shield electrode 130 is disposed below the elastic dielectric body 120 in a state in which the shield electrode 130 is disposed on the upper surface of the substrate 102. That is, the shield electrode 130 is disposed on the back side of a plurality of front-side electrodes 110 with the elastic dielectric body 120 interposed between the shield electrode 130 and the plurality of front-side electrodes 110. The shield electrode 130 is provided to shield the plurality of front-side electrodes 110 from noise and to suppress a parasitic capacitance between the plurality of front-side electrodes 110 and the ground. An alternating-current voltage V_{C1} or V_{C2}, resulting from amplifying, in the variable amplification circuit 140C, an output supplied from the power supply circuit 145, is applied to the shield electrode 130. The alternating-current voltages V_{C1} and V_{C2} are each an example of a second alternating-current voltage and are also each an example of a second alternating-current voltage having a plurality of amplitudes. The shield electrode 130 is formed from a transparent conductive material such as an ITO film, as an example. The substrate 102 is a transparent substrate that holds the shield electrode 130. When a display panel is not placed underneath, for example, the shield electrode 130 and the substrate 102 that holds the shield electrode 130 may not be transparent.

The amplification circuit 140A amplifies an alternating-current voltage output from the power supply circuit 145 to the alternating-current voltage V_{A} and outputs it to the driving electrode 112. The amplification circuit 140A is structured so as to be selectively connectable to all of the plurality of front-side electrodes 110 through the selection unit 160A, as an example. The amplification circuit 140A is connected to two front-side electrodes 110 selected as the driving electrodes 112 through switching by the selection unit 160A among the connections of wires to all of the plurality of front-side electrodes 110, and outputs the alternating-current voltage V_{A}. As described above, two or more front-side electrodes 110 that are not mutually adjacent may be concurrently selected as the detection electrodes 111 to concurrently perform detection of a proximity of, a contact of, and pressing with the fingertip FT. To do this, the amplification circuit 140A outputs the alternating-current voltage V_{A} to the driving electrodes 112 coupled to one or more detection electrodes 111 with capacitances interposed between the driving electrodes 112 and the detection electrodes 111.

The amplification circuit 140B is connected to a non-inverting input terminal (+) of an op-amp 152 in the detection unit 150. The amplification circuit 140B amplifies an alternating-current voltage output from the power supply circuit 145 to the alternating-current voltage V_{B} and output it. The op-amp 152 is an example of an operational amplifier. The alternating-current voltage V_{B} has an amplitude of V_{B}, which is equal to or lower than the alternating-current voltage V_{A} (V_{A}≥V_{B}). The frequency of the alternating-current voltage V_{B} is equal to the frequency of the alternating-current voltage V_{A}. The phase of the alternating-current voltage V_{B} is also equal to the phase of the alternating-current voltage V_{A} (these voltages are in phase). The amplification circuit 140B may output the alternating-current voltage V_{B} through the detection unit 150 to the front-side electrode 110 selected as the detection electrode 111 by the selection unit 160B, as will be described later in detail.

The variable amplification circuit 140C is connected to the shield electrode 130. The variable amplification circuit 140C amplifies an alternating-current voltage output from the power supply circuit 145 to the alternating-current voltage V_{C1} or V_{C2} and output it. The alternating-current voltages V_{C1} and V_{C2} respectively have amplitudes of V_{C1} and V_{C2}. The variable amplification circuit 140C can change the amplitude of the second alternating-current voltage to a plurality of amplitudes when an amplification ratio is controlled by the control device 170. It will be assumed here that the alternating-current voltage output from the power supply circuit 145 is amplified to the alternating-current voltage V_{C1} or V_{C2} (V_{C1}>V_{C2}) and the amplified voltage is output. The amplitudes V_{C1} and V_{C2} of the alternating-current voltages V_{C1} and V_{C2} are smaller than the amplitude V_{B} of the alternating-current voltage V_{B} (V_{B}>V_{C1}>V_{C2}). The alternating-current voltages V_{C1} and V_{C2} each have a frequency equal to the frequencies of the alternating-current voltage V_{A} and alternating-current voltage V_{B}. To detect a capacitance (specifically, an electrostatic capacity) Cs between the detection electrode 111 and the shield electrode 130 with an alternating-current voltage having two types of amplitudes, the variable amplification circuit 140C is structured so that it can change the amplitude of the alternating-current voltage to V_{C1} or V_{C2}, as will be described later in detail.

The power supply circuit 145 outputs an alternating-current voltage at a predetermined frequency. The amplification circuit 140A, amplification circuit 140B, and variable amplification circuit 140C are connected to the output side of the power supply circuit 145. The alternating-current voltage at the predetermined frequency, output from the power supply circuit 145, is entered into the amplification circuit 140A, amplification circuit 140B, and variable amplification circuit 140C, and is then amplified therein. Therefore, the alternating-current voltage V_{A}, V_{B}, V_{C1}, and V_{C2}, which are respectively output from the amplification circuit 140A, amplification circuit 140B, and variable amplification circuit 140C, have the same frequency and the same phase.

The detection unit 150 has an input terminal 151, the op-amp 152, a capacitor 153, a resistor 154, and an output terminal 155. The detection unit 150 detects a proximity of, a contact of, and pressing with the fingertip FT of the user by using the detection electrode 111.

The input terminal 151 is structured so as to be selectively connectable to all of the plurality of front-side electrodes 110 through the selection unit 160B, as an example. When a wire is switched in the selection unit 160B to select a detection electrode 111, the input terminal 151 is connected to the detection electrode 111 selected by the selection unit 160B. The input terminal 151 outputs the alternating-current voltage V_{B} to the detection electrode 111 selected by the selection unit 160B.

The op-amp 152 may have an inverting input terminal (−) connected to the detection electrode 111, which has been selected by the selection unit 160B, through the input terminal 151 of the detection unit 150, the non-inverting input terminal (+) that is connected to the amplification circuit 140B and to which the alternating-current voltage V_{B} is input, and an output terminal connected to the output terminal 155. Since a negative feedback operation is performed by the capacitor 153 and resistor 154, which are feedback elements, the op-amp 152 performs an amplification operation so that the difference between the voltage of the inverting input terminal (−) and the voltage of the non-inverting input terminal (+) becomes zero. Therefore, due to a virtual short-circuit in the op-amp 152, which is used as a non-inverting amplification circuit, the voltage at the inverting input terminal (−) becomes equal to a voltage to be applied to the non-inverting input terminal (+). Therefore, the alternating-current voltage V_{B} is applied to the detection electrode 111.

The capacitor 153 is connected between the inverting input terminal (−) of the op-amp 152 and its output terminal. The capacitance (specifically, an electrostatic capacity) of the capacitor 153 is Cq. The resistor 154 is connected in parallel to the capacitor 153. The resistance of the resistor 154 is Rq.

The output terminal 155 is connected to the output terminal of the op-amp 152, and is also connected to the control device 170. The output voltage of the output terminal 155 is V₀. A negative feedback operation is performed by the capacitor 153 and resistor 154, which are feedback elements. In the op-amp 152, therefore, due to a virtual short-circuit, the voltage of the inverting input terminal (−) becomes equal to a voltage to be applied to the non-inverting input terminal (+). Therefore, the alternating-current voltage V_{B} is output to the input terminal 151, and the alternating-current voltage V_{B} is applied to the detection electrode 111 through the selection unit 160B.

The selection unit 160A has an input terminal connected to the amplification circuit 140A as well as a plurality of output terminals connected to all of the plurality of front-side electrodes 110. The selection unit 160A switches the connection destination of the input terminal to two output terminals connected to two front-side electrodes 110 of the plurality of front-side electrodes 110, in response to a command entered from the control device 170. The selection unit 160A selects two front-side electrodes 110 as the driving electrodes 112 in this way. The selection unit 160A outputs the alternating-current voltage V_{A}, entered from the amplification circuit 140A, to the two driving electrodes 112. A selector, for example, can be used as the selection unit 160A of this type.

The selection unit 160B has an input terminal connected to the input terminal 151 of the detection unit 150 as well as a plurality of output terminals connected to all of the plurality of front-side electrodes 110. The selection unit 160B switches the connection destination of the input terminal to one output terminal connected to one front-side electrode 110 of the plurality of front-side electrodes 110, in response to a command entered from the control device 170. The selection unit 160B selects one front-side electrode 110 as the detection electrode 111 in this way. The selection unit 160B outputs the alternating-current voltage V_{B}, entered from the amplification circuit 140B through the detection unit 150, to the detection electrode 111. A selector, for example, can be used as the selection unit 160B of this type.

The control device 170 is implemented by a computer that includes a central processing unit (CPU), a random-access memory (RAM), a read-only memory (ROM), an input/output interface, an internal bus, and the like. The control device 170 has the operation decision unit 171 and holding unit 172. In addition to the operation decision unit 171 and holding unit 172, the control device 170 has processing units and the like that perform switching of the amplification ratio of the variable amplification circuit 140C (ratio according to which amplification to the alternating-current voltage V_{C1} or V_{C2} is performed), switching by the selection units 160A and 160B, and the like. However, descriptions of these units will be omitted here. The operation decision unit 171 represents one function of the control device 170 as a block. The holding unit 172 functionally represents the RAM in the control device 170.

The operation decision unit 171 detects a proximity of, a contact of, and pressing with the fingertip FT according to the output voltage V₀ from the output terminal 155 of the detection unit 150. A specific detection method will be described later.

When the operation decision unit 171 detects a proximity of, a contact of, and pressing with the fingertip FT according to the output voltage V₀, the holding unit 172 temporarily stores data representing the output voltage V₀, as will be described later in detail.

The plurality of front-side electrodes 110 are arranged at equal intervals in the X direction and Y direction. A capacitance (specifically, an electrostatic capacity) is present between adjacent front-side electrodes 110. That is, the detection electrode 111 and driving electrode 112 are coupled together with a capacitance interposed between them. In other words, the driving electrode 112 is coupled to the detection electrode 111 with a capacitance interposed between them. A capacitance between the detection electrode 111 and the driving electrode 112 on the −X-direction side will be denoted Cp1, and a capacitance between the detection electrode 111 and the driving electrode 112 on the +X-direction side will be denoted Cp2. The capacitances Cp1 and Cp2 each have a constant value.

A capacitance (specifically, an electrostatic capacity) generated between the detection electrode 111 and the fingertip FT will be denoted Cf. The capacitance Cf becomes larger as the fingertip FT comes closer to the detection electrode 111. Since the cover 101 is present between the detection electrode 111 and the fingertip FT, when the fingertip FT comes close to the detection electrode 111, the capacitance Cf is increased until the fingertip FT comes into contact with a portion, on the upper surface of the cover 101, immediately above the relevant detection electrodes 111. When a pressing manipulation to press the cover 101 downward is performed with the fingertip FT, the fingertip FT is deformed and its area in contact with the cover 101 is increased, so the capacitance Cf is further increased according the increase in the pressing force.

A capacitance (specifically, an electrostatic capacity) between the detection electrode 111 and the shield electrode 130 will be denoted Cs. When the user presses a portion, on the upper surface of the cover 101, immediately above the relevant detection electrode 111, in the downward direction with the fingertip FT, the elastic dielectric body 120 warps and contracts, by which the distance d between the detection electrode 111 and the shield electrode 130 is shortened. Thus, when a pressing manipulation is performed, the capacitance Cs increases according the distance d between the detection electrode 111 and the shield electrode 130.

Thus, when the user performs a pressing manipulation to press the cover 101 downward with the fingertip FT, both the capacitance Cf and the capacitance Cs increase. When both the capacitance Cf and the capacitance Cs increase, it may be difficult to decide that a pressing manipulation has been performed. In view of this, with the capacitive sensor 100, the amplitude of the alternating-current voltage output from the variable amplification circuit 140C is set to V_{C1} and V_{C2} at different times so that the operation decision unit 171 can decide that a pressing manipulation has been performed.

The alternating-current voltage V_{C1} or V_{C2} output from the variable amplification circuit 140C is applied to the shield electrode 130. Since the capacitance Cf is between the detection electrode 111 and the fingertip FT and the capacitance Cs is between the detection electrode 111 and the shield electrode 130, a change (V_{C1}−V_{C2}) between alternating-current voltages V_{C1} and V_{C2} output from the variable amplification circuit 140C affects the capacitance Cs and does not affect the capacitance Cf.

Therefore, to use the detection electrode 111 selected by the selection unit 160B to decide that a pressing manipulation has been performed, after outputting the alternating-current voltage with the amplitude V_{C1} to the variable amplification circuit 140C, the capacitive sensor 100 changes the amplitude to V_{C2} and applies an alternating-current voltage with the amplitude V_{C2}. Actually, all of the plurality of front-side electrodes 110 arranged in a matrix are sequentially selected by the selection unit 160B one by one, and the selected front-side electrode 110 is used as the detection electrode 111. A decision is made for each detection electrode 111 about the position of the fingertip FT and about whether a pressing manipulation has been performed, while a selection operation as described above is repeated to repeatedly select all front-side electrodes 110 as the detection electrode 111 again and again. Therefore, each time one front-side electrode 110 is selected as the detection electrode 111 by the selection unit 160B, the variable amplification circuit 140C outputs an alternating-current voltage with the amplitude V_{C2} immediately after outputting an alternating-current voltage with the amplitude V_{C1}. This is done to detect, in a state in which the position of the fingertip FT remains substantially unchanged, both the capacitance Cs when an alternating-current voltage with the amplitude V_{C1} is applied to the shield electrode 130 and the capacitance Cs when an alternating-current voltage with the amplitude V_{C2} is applied.

Although the operation decision unit 171 may decide a proximity and contact of the fingertip FT regardless of whether the variable amplification circuit 140C outputs the alternating-current voltage V_{C1} or V_{C2}, it will be assumed here as an example that the operation decision unit 171 decides a proximity and contact of the fingertip FT according to the capacitance Cf when the variable amplification circuit 140C outputs the alternating-current voltage V_{C1}. The above order in which the variable amplification circuit 140C outputs an alternating-current voltage with the amplitude V_{C1} and an alternating-current voltage with the amplitude V_{C2} for each detection electrode 111 is not a limitation. In a state in which each front-side electrode 110 is selected as the detection electrode 111, the variable amplification circuit 140C may output an alternating-current voltage with the amplitude V_{C2} before outputting an alternating-current voltage with the amplitude V_{C1}.

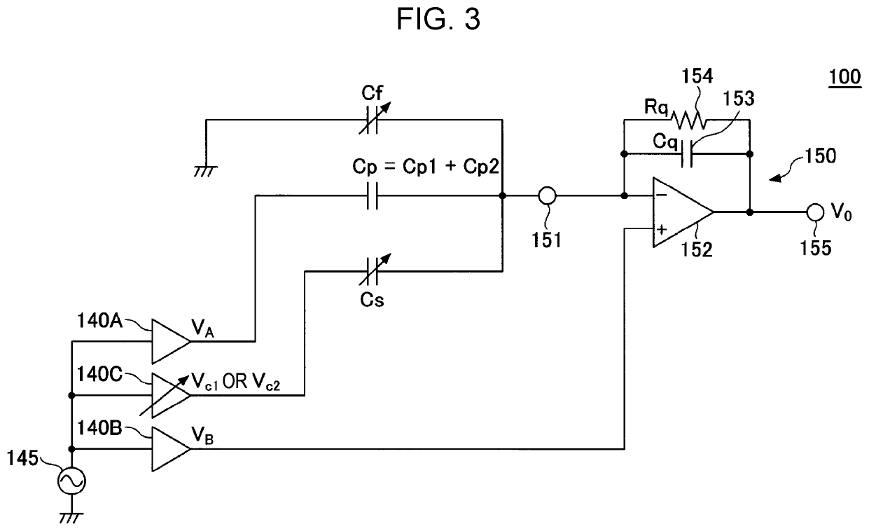

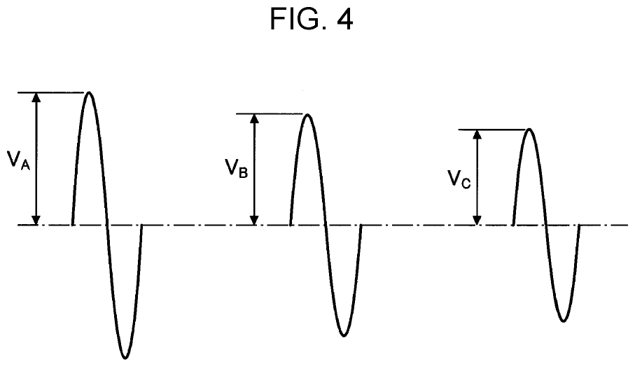

When the amplitude of the alternating-current voltage to be output from the variable amplification circuit 140C is set to V_{C1} and V_{C2} and the operation decision unit 171 detects a pressing manipulation, the output voltage V₀ from the output terminal 155 is used. Therefore, before a method is described in which the operation decision unit 171 makes a decision about whether a pressing manipulation has been performed, the method of obtaining the output voltage V₀ as well as a relation among the amplitudes of the alternating-current voltage V_{A}, alternating-current voltage V_{B}, and alternating-current voltages V_{C1} and V_{C2} will be described here with reference to FIGS. 3 and 4.

FIG. 3 illustrates an equivalent circuit of the capacitive sensor 100. In FIG. 3, an equivalent circuit of a portion, in the capacitive sensor 100, in which in the control device 170 is removed is illustrated. Since the capacitance Cf changes according to the distance between the fingertip FT and the detection electrode 111 and to the contact area of the fingertip FT, the capacitance Cf is illustrated as a variable capacitance. Similarly, since the capacitance Cs changes according to the distance d, which depends on the pressing manipulation, between the detection electrode 111 and the shield electrode 130, the capacitance Cs is illustrated as a variable capacitance. In the description below, when the alternating-current voltages V_{C1} and V_{C2} are not distinguished from each other, they will be referred to as the alternating-current voltage V_{C}. Since there is the relation of V_{B}>V_{C1}→V_{C2}, V_{B} is greater than V_{C}.

In the capacitive sensor 100 having this type of structure, equation (1) below may hold. Equation (1) holds among the detection electrode 111, driving electrode 112, and shield electrode 130 according to the law of conservation of electric charge. Equation (1) means that a voltage obtained by integration with the capacitor 153 having the capacitance Cq is the output voltage V₀. The capacitance Cp is equal to Cp1+Cp2. When four driving electrodes 112 are used, the capacitance Cp is the total value of four capacitances generated among the detection electrode 111 and the four driving electrodes 112.

$$Cf \times {V}_{B} + ( {V}_{B} - {V}_{A} ) \times Cp + ( {V}_{B} - {V}_{C} ) \times Cs = Cq \times {V}_{O} \qquad ( 1 )$$

When equation (1) is rewritten, the output voltage V₀ from the output terminal 155 is represented as in the following equation (2).

$$\frac{Cf \times {V}_{B} + ( {V}_{B} - {V}_{A} ) \times Cp + ( {V}_{B} - {V}_{C} ) \times Cs}{Cq} = {V}_{O} \qquad ( 2 )$$

The capacitance Cs between the detection electrode 111 and the shield electrode 130 is represented as in the following equation (3). In equation (3), 80 is a dielectric constant in a vacuum, εr is the specific inductive capacity of the elastic dielectric body 120, s is the area of the detection electrode 111, and d is the distance (gap) between the detection electrode 111 and the shield electrode 130. When the distance d is reduced, the capacitance Cs increases.

$$Cs = {ε}_{0} {ε}_{r} \frac{s}{d} \qquad ( 3 )$$

Since the operation decision unit 171 makes a decision about a proximity and contact of the fingertip FT according to the capacitance Cf when, as an example, the variable amplification circuit 140C outputs the alternating-current voltage V_{C1}, the output voltage V₀ can be obtained by assigning V_{C1} to V_{C} in equation (2).

FIG. 4 illustrates examples of the waveforms of the alternating-current voltage V_{A}, alternating-current voltage V_{B}, and alternating-current voltage V_{C}. In the capacitive sensor 100, the alternating-current voltage V_{A}, alternating-current voltage V_{B}, and alternating-current voltage V_{C} have the relation of V_{A}>V_{B}>V_{C}. That is, the amplitude of the alternating-current voltage V_{A} is larger than or equal to the amplitude of the alternating-current voltage V_{B}, and the amplitude of the alternating-current voltage V_{C} is smaller than the amplitude of the alternating-current voltage V_{B}.

Here, as an example, the alternating-current voltage V_{A}, alternating-current voltage V_{B}, and alternating-current voltage V_{C} are made mutually different so that they have the relation of V_{A}>V_{B}>V_{C} as illustrated in FIG. 4. The reason why they have the relation of V_{A}≥V_{B}>V_{C} will be described.

In equation (2), the capacitance Cf and capacitance Cs included in the capacitances of individual portions change according to the degree of proximity and the degree of pressing. To detect a proximity of, a contact of, and pressing with the fingertip FT for the cover 101 on the detection electrodes 111 only from the output voltage V₀, it suffices for the output voltage V₀ to increase in the order of the proximity, contact, and pressing.

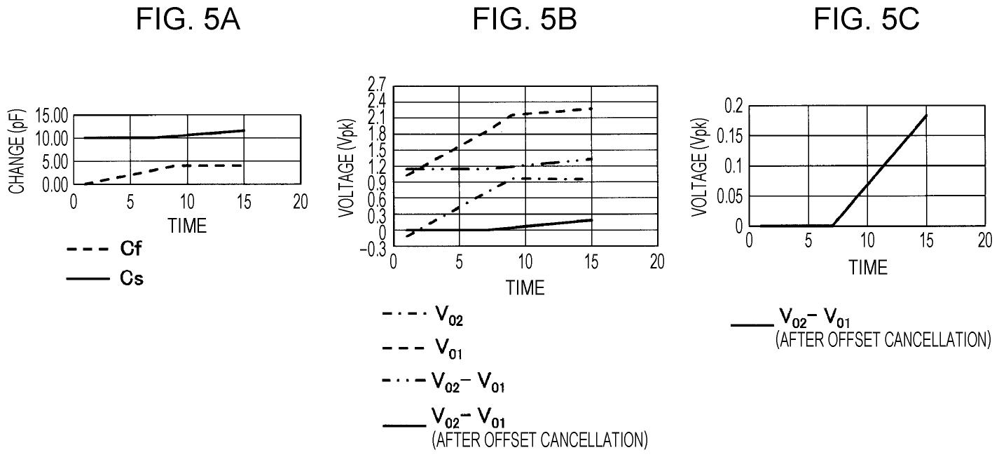

As to whether a proximity has been performed and as to whether a contact has been made, a decision is made by using decision threshold values V1 and V2 for the output voltage V₀. As to whether pressing has been performed, a decision is made according to a method, which will be described later with reference to FIGS. 5A to 5C. Here, a method of deciding whether a proximity has been made and whether a contact has been made will be described.

When a decision threshold value for proximity is denoted V1 and a decision threshold value for a contact is denoted V2, it will be assumed that these decision thresholds have the relation of V1<V2. Then, it is only needed that a proximity is detected when the amplitude V₀ of the output voltage V₀ becomes larger than or equal to V1 and smaller than V2 and that a contact is detected when the amplitude V₀ of the output voltage V₀ becomes larger than or equal to V2. Thus, a proximity and contact of the fingertip FT for the cover 101 can be detected according to the amplitude V₀ of the output voltage V₀.

The value of the term Cf×V_{B} in equation (2) increases as the fingertip FT comes close to the cover 101. To have the value of the term (V_{B}—V_{C})×Cs in equation (2) increase as the cover 101 is pressed with the fingertip FT, it suffices for the relation of alternating-current voltage V_{B}>alternating-current voltage V_{C} to hold. Thus, the relation of alternating-current voltage V_{B}>alternating-current voltage V_{C} holds.

The effect of the parasitic capacitance between the detection electrode 111 and the ground and capacitive couplings other than a capacitive coupling between the detection electrode 111 and the shield electrode 130 immediately below the detection electrode 111 are reduced by making the alternating-current voltage V_{A} to be applied to the driving electrode 112 larger than the alternating-current voltage V_{B}. When the effect of the parasitic capacitance between the detection electrode 111 and the ground is small, the alternating-current voltage V_{A} and alternating-current voltage V_{B} may be equal to each other. Thus, it suffices for the relation of alternating-current voltage V_{A}≥alternating-current voltage V_{B} to hold.

When the relation of alternating-current voltage V_{A}>alternating-current voltage V_{B} described above is used, increases in the value of the term Cf×V_{B} in equation (2) and the value of the term (V_{B}—V_{C})×Cs in equation (2) can be stably reflected in the output voltage V₀ in the process in which a proximity of, a contact of, and pressing with the fingertip FT for the cover 101 are performed. In this embodiment, the relation of alternating-current voltage V_{A}>alternating-current voltage V_{B} is satisfied, as an example.

As to whether pressing has been performed, a decision is made by using a method described later with reference to FIGS. 5A and 5B. Therefore, the value of the term (V_{B}—V_{C})×Cs in equation (2) may not increase as the cover 101 is pressed with the fingertip FT. When the relation of alternating-current voltage V_{B}>alternating-current voltage V_{C} holds, this contributes to an increase in the value of the term (V_{B}—V_{C})×Cs in equation (2) as the cover 101 is pressed with the fingertip FT, so an increase in the degree of pressing is likely to be decided according to an increase in the value of the output voltage V₀. However, the relation of alternating-current voltage V_{B}>alternating-current voltage V_{C} is not a necessity.

FIGS. 5A to 5C illustrate time-varying changes in the capacitances Cf and Cs and output voltage V₀ in the capacitive sensor 100. In FIG. 5A, the horizontal axis represents time (with no unit) and the vertical axis represents the capacitances Cf and Cs (pF). In FIG. 5A, time 0 is time in a state in which the fingertip FT is not present in a range in which detection by the capacitive sensor 100 is possible (non-manipulation state). As time elapses, the fingertip FT comes close to the surface of the cover 101 and comes into contact with it. At about time 7, the fingertip FT presses the surface.

As time elapses from time 0, the capacitances Cf and Cs increase as illustrated in FIG. 5A, in which case the amount of change in capacitance Cs is smaller than the amount of change in capacitance Cf. When the surface of the cover 101 is pressed at about time 7 or later, the capacitance Cs subtly increases. However, the capacitance Cf also increases until time reaches about 8.5. Therefore, it is difficult to make a decision, only from the capacitance Cs, about whether pressing has been performed.

In FIG. 5B, an output voltage V₀₁ and an output voltage V₀₂, which are obtained for the detection electrode 111 present at a position at which pressing is performed with the fingertip FT, are respectively indicated by a dashed line and a dash-dot line. A voltage obtained from V₀₂−V₀₁ is also indicated by a dash-dot-dot line. A voltage (after offset cancellation) resulting from canceling an offset voltage from the voltage obtained from V₀₂−V₀₁ is also indicated by a solid line. In FIG. 5C, a graph is illustrated in which the scale of the vertical axis of V₀₂−V₀₁ (after offset cancellation) indicated by the solid line in FIG. 5B is made small.

The output voltage V₀₁ is output from the detection unit 150 while the variable amplification circuit 140C outputs the alternating-current voltage V_{C1}. That is, the output voltage V₀₁ is obtained by assigning V_{C1} to V_{C} in equation (2). Similarly, the output voltage V₀₂ is output from the detection unit 150 while the variable amplification circuit 140C outputs the alternating-current voltage V_{C2}. That is, the output voltage V₀₂ is obtained by assigning V_{C2} to V_{C} in equation (2). Since there is the relation of V_{C}1>V_{C2}, V₀₁<V₀₂ holds. Therefore, V₀₂−V₀₁ (>0) is used as the difference in voltage. The voltage V₀₂−V₀₁ is obtained by subtracting the output voltage V₀₁ from the output voltage V₀₂. The voltage V₀₂−V₀₁ (after offset cancellation) is obtained by deleting, from the voltage V₀₂−V₀₁, the values of the output voltages V₀₁ and V₀₂ in a state in which the fingertip FT is not present in the range in which detection by the capacitive sensor 100 is possible (non-manipulation state).

With each detection electrode 111 selected, after having output an alternating-current voltage with the amplitude V_{C1}, the variable amplification circuit 140C applies an alternating-current voltage with the amplitude V_{C2}, as an example. Therefore, the output voltage V₀₁ is obtained earlier than the output voltage V₀₂. The output voltages V₀₁ and V₀₂ are temporarily held in the holding unit 172. The operation decision unit 171 may make a decision about whether pressing has been performed, according to the output voltages V₀₁ and V₀₂ held in the holding unit 172. In the graph representing the output voltage V₀₁, output voltage V₀₂, voltage V₀₂−V₀₁, and voltage V₀₂−V₀₁ (after offset cancellation) illustrated in FIG. 5B, the values of the output voltage V₀₁, output voltage V₀₂, voltage V₀₂−V₀₁, and voltage V₀₂−V₀₁ (after offset cancellation) are arranged in time series, the values being obtained for the detection electrode 111 at a position at which pressing is performed with the fingertip FT while selection of each detection electrode 111 is repeatedly performed.

As illustrated in FIG. 5B, although the output voltages V₀₁ and V₀₂ have different voltage values, they similarly change as time elapses. Also as illustrated in FIG. 5B, the voltages V₀₂−V₀₁ and V₀₂−V₀₁ (after offset cancellation) differ only in voltage value and similarly change as time elapses.

The voltage V₀₂−V₀₁ (after offset cancellation) indicted in FIG. 5C, in which it is enlarged, rises from 0 V at the point when time is at about 7, the point matching the point in time at which the fingertip FT started pressing. Thus, if the operation decision unit 171 uses an appropriate threshold value for the difference between the output voltages V₀₁ and V₀₂, which are obtained by changing the output of the variable amplification circuit 140C to the alternating-current voltages V_{C1} and V_{C2}, to make a decision about whether pressing has been performed, it is possible to remove the effect of the change in the capacitance Cf and to accurately detect that pressing has been performed.

Therefore, it is possible to provide the capacitive sensor 100 that can easily detect that the cover 101 has been pressed with the fingertip FT.

The detection unit 150, which has the op-amp 152 that has an inverting input terminal connected to one or more detection electrodes 111 as well as a non-inverting input terminal connected to the amplification circuit 140B, perform a negative feedback operation. Therefore, the alternating-current voltage V_{B} entered into the non-inverting input terminal can be reflected in the inverting input terminal and can then be applied to the detection electrode 111. Therefore, it is possible to accurately detect that the cover 101 has been pressed with the fingertip FT.

The output voltage V₀ is represented as in equation (1). Therefore, it is possible to accurately detect that the cover 101 has been pressed with the fingertip FT, according to the output voltage V₀.

The amplitudes of the alternating-current voltage V_{A}, alternating-current voltage V_{B}, and alternating-current voltage V_{C} may be set to the amplitudes V_{A}, V_{B}, and V_{C} by which the term (V_{B}—V_{A})×Cp and the term (V_{B}—V_{C})×Cs in equation (1) cancel each other in a state in which pressing with the fingertip FT is not being performed. Therefore, the dynamic range of the capacitance Cf can be increased in equation (2).

Even in a state in which the fingertip FT is not present (non-manipulation state), the capacitive sensor 100 outputs the output voltage V₀ matching capacitances generated between the detection electrode 111 and the driving electrode 112 and between the detection electrode 111 and a surrounding object.

To make it easy to detect the proximity of the FT when the fingertip FT starts to comes close to the detection electrode 111 in the non-manipulation state, it suffices to increase the dynamic range of the capacitance Cf. When the alternating-current voltage V_{A}, alternating-current voltage V_{B}, and alternating-current voltage V_{C} have a relationship in which the term (V_{B}−V_{A})×Cp and the term (V_{B}—V_{C})×Cs in equation (2) cancel each other in the non-manipulation state, the dynamic range of the capacitance Cf can be increased in equation (2).

Therefore, the alternating-current voltage V_{A}, alternating-current voltage V_{B}, and alternating-current voltage V_{C} may be set to the amplitudes V_{A}, V_{B}, and V_{C} by which the term (V_{B}—V_{A})×Cp and the term (V_{B}—V_{C})×Cs cancel each other in the non-manipulation state. Then, it becomes easy to detect the proximity of the fingertip FT toward the cover 101 in the non-manipulation state.

Since the amplification circuit 140B outputs the alternating-current voltage V_{B} to the detection electrode 111 selected by the selection unit 160B, the detection electrode 111 can be reliably selected with a simple structure and it can be easily detected that the cover 101 has been pressed with the fingertip FT.

When the variable amplification circuit 140C sets the amplitude of the alternating-current voltage V_{C} to a predetermined amplitude (V_{C1}, for example), the operation decision unit 171 may decide that a proximity or contact of the fingertip FT for the cover 101 has been performed, according to the output (V₀₁, for example) from the detection unit 150. In addition to pressing, therefore, a proximity and a contact can also be detected. Thus, different functions can be assigned to a contact and pressing so that, for example, when a contact is made, content displayed at the contact position, the content being represented by a graphic user interface (GUI) or the like, is selected; and when pressing is performed, the selected content is established.

The operation decision unit 171 may decide that pressing has been performed, according to a plurality of output voltages (V₀₁ and V₀₂, for example) from the detection unit 150, the voltages being held in the holding unit 172 when the variable amplification circuit 140C changes the amplitude of the alternating-current voltage V_{C} to a plurality of amplitudes (V_{C1} and V_{C2}, for example). Therefore, it is possible to reliably hold a plurality of output voltages (V₀₁ and V₀₂, for example) obtained at different times in time series and it is possible to accurately detect that the cover 101 has been pressed with the fingertip FT.

In a state in which the detection unit 150 is connected to a particular detection electrode 111, the operation decision unit 171 decides that pressing has been performed at the position, on the cover 101, corresponding to the connected detection electrode 111, according to a plurality of output voltages (V₀₁ and V₀₂, for example) from the detection unit 150, the plurality of output voltages being obtained when the variable amplification circuit 140C changes the amplitude of the alternating-current voltage V_{C} to a plurality of amplitudes (V_{c1} and V_{c2}, for example) for each connected detection electrode 111. Thus, it is possible to detect the capacitance Cs at a time when an alternating-current voltage (V_{C1} or V_{C2}, for example) with a plurality of amplitudes is applied to the shield electrode 130 in a state in which the position of the fingertip FT on the cover 101 remains substantially unchanged and to accurately detect that the cover 101 has been pressed with the fingertip FT by using the difference in output voltages (alternating-current voltages (V_{C1} and V_{C2}, for example) based on the difference between the applied alternating-current voltages (V_{C1} and V_{C2}, for example).

As a driving unit to which to apply the alternating-current voltage V_{A}, front-side electrodes 110 adjacent to the detection electrode 111 may be used as driving electrodes 112, the front-side electrodes 110 being included in a plurality of front-side electrodes 110, the front-side electrodes 110 being other than the detection electrode 111. Therefore, by using the capacitance Cp between the detection electrode 111 and the driving electrode 112, a proximity of, a contact of, and pressing with the fingertip FT for the cover 101 can be detected according to the output voltage V₀. Since the capacitance Cp between the detection electrode 111 and each driving electrode 112 is used, a proximity of, a contact of, and pressing with the fingertip FT for the cover 101 can be stably detected by using the capacitance Cp between adjacent front-side electrodes 110, according to output voltage V₀.

The alternating-current voltage V_{A}, alternating-current voltage V_{B}, and alternating-current voltage V_{C} may have the relation of V_{A}>V_{B}>V_{C}. When the alternating-current voltage V_{A}, alternating-current voltage V_{B}, and alternating-current voltage V_{C} having this relationship are used, the output voltage V₀ increases along with a proximity of, a contact of, and pressing with the fingertip FT. Therefore, it is possible to make it easy to make a decision about the motion of the fingertip FT, according to the output voltage V₀.

In a state in which the amplification circuit 140A and two front-side electrodes 110 selected as the driving electrode 112 by the selection unit 160A are connected together and the input terminal 151 and a front-side electrode 110 selected as the detection electrode 111 by the selection unit 160B are connected together, the capacitive sensor 100 can detect a proximity of, a contact of, and pressing with the fingertip FT for the cover 101 according to the output voltage V₀ from the output terminal 155 of the detection unit 150, without having to perform, for example, switching of circuits for the detection electrode 111 and driving electrodes 112.

Since only the output voltage V₀ is used as a single signal to detect a proximity, a contact, and pressing, wires for connecting a plurality of front-side electrodes 110, the amplification circuit 140A, the amplification circuit 140B, the variable amplification circuit 140C, the power supply circuit 145, and the detection unit 150 together are minimized, so it is also possible to downsize the detection unit 150. Therefore, the capacitive sensor 100 having a simple structure can be provided.

Another advantage of using only the output voltage V₀ as a single signal to detect a proximity, a contact, and pressing is that an increase in time required for processing to detect a proximity, a contact, and pressing can be suppressed to a minimum. Therefore, processing time taken for detecting a proximity, a contact, and pressing can be reduced.

Since the alternating-current voltage V_{A}, alternating-current voltage V_{B}, and alternating-current voltage V_{C} are sine waves, when the amplification circuit 140A, amplification circuit 140B, variable amplification circuit 140C, and the power supply circuit 145 are used, the output voltage V₀ can be easily obtained according to equation (2). In addition, a proximity of, a contact of, and pressing with the fingertip FT for the cover 101 can be stably detected according the output voltage V₀ obtained in this way.

An aspect has been described above in which an alternating-current voltage having a predetermined frequency, the alternating-current voltage being output from the power supply circuit 145, is amplified by the amplification circuit 140A, amplification circuit 140B, and variable amplification circuit 140C, after which the resulting alternating-current voltages V_{A}, V_{B}, V_{C1}, and V_{C2} are output. However, the circuits that output the alternating-current voltages V_{A}, V_{B}, V_{C1}, and V_{C2} are not limited to circuits as described above. It is only necessary that the circuits can make the alternating-current voltages V_{A}, V_{B}, V_{C1}, and V_{C2} have the same phase and can adjust these alternating-current voltages to appropriate amplitudes. For example, when a circuit that makes a plurality of power supplies have the same phase is provided, a plurality of power supply circuits may be provided.

An aspect has been described above in which the alternating-current voltage V_{A}, alternating-current voltage V_{B}, and alternating-current voltage V_{C} are sine waves. However, the alternating-current voltage V_{A}, alternating-current voltage V_{B}, and alternating-current voltage V_{C} may be square waves. In this case, it suffices for the power supply circuit 145 to output alternating-current voltages in a square wave shape instead of alternating-current voltages in a sine wave shape. Even when square waves are used instead of sine waves, a proximity of, a contact of, and pressing with the fingertip FT for the cover 101 can be similarly detected according to the amplitude V₀ of the output voltage V₀.

An aspect has been described above in which a plurality of front-side electrodes 110 arranged in a matrix as illustrated in FIG. 1 are used. However, the plurality of front-side electrodes 110 included in the capacitive sensor 100 are not limited to this type of structure. For example, the plurality of front-side electrodes 110 may be structured so as to detect a proximity of, a contact of, and pressing with the fingertip FT for the cover 101, according a change in capacitance between a plurality of electrodes that extend in the row-wise direction (X direction) and are arranged in the Y direction and a plurality of electrodes that extend in the column-wise direction (Y direction) and are arranged in the X direction. The plurality of electrodes that extend in the row-wise direction (X direction) and are arranged in the Y direction may be electrodes patterned in a diamond shape in plan view. This is also true for the plurality of electrodes that extend in the column-wise direction (Y direction) and are arranged in the X direction.

### Embodiment 2

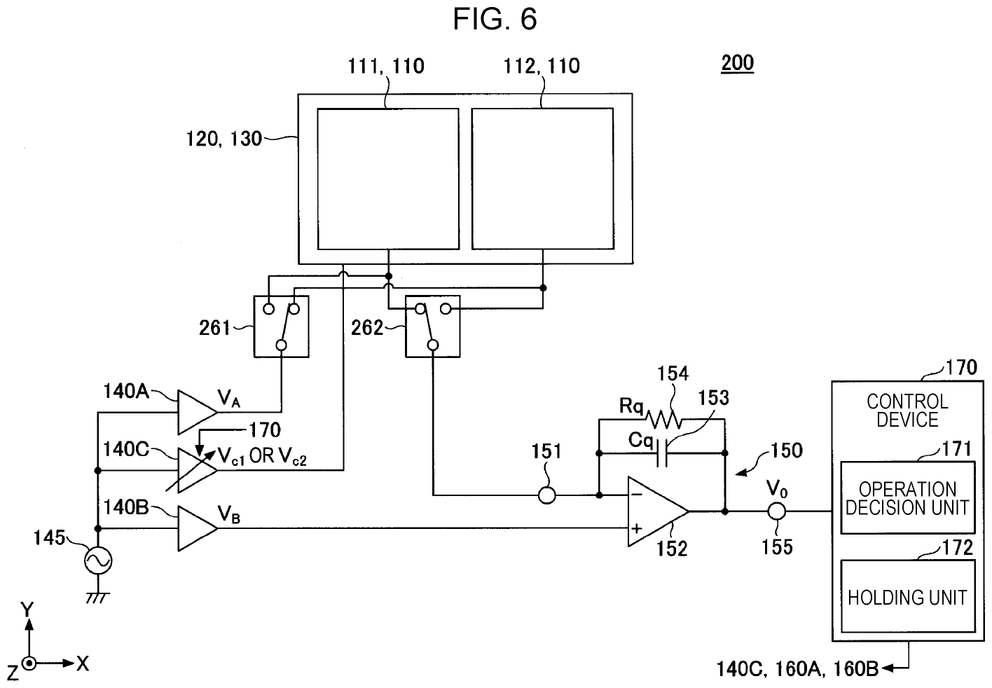

FIG. 6 illustrates a capacitive sensor 200 in embodiment 2. The capacitive sensor 200 includes the detection electrode 111, the driving electrode 112, the elastic dielectric body 120, the shield electrode 130, the amplification circuit 140A, the amplification circuit 140B, the variable amplification circuit 140C, the power supply circuit 145, the detection unit 150, and selector switches 261 and 262. The selector switches 261 and 262 are each an example of a selection unit that selects one or more detection electrodes 111 from the front-side electrodes 110. In FIG. 6, the structures of the detection electrode 111, driving electrode 112, elastic dielectric body 120, and shield electrode 130 are illustrated as being planar in an XY plane. In FIG. 6, the cover 101 is omitted.

In embodiment 2, an aspect will be described in which the capacitive sensor 200 includes two front-side electrodes 110, one of which is used as the detection electrode 111 and the other of which is used as the driving electrode 112. Constituent elements similar to those of the capacitive sensor 100 in embodiment 1 will be given identical reference characters and descriptions of these constituent elements will be omitted.

The selector switches 261 and 262 are each a three-terminal switch. They can switch the connection destinations of the amplification circuit 140A and input terminal 151 between the detection electrode 111 and the driving electrode 112. In FIG. 6, the front-side electrode 110 on the −X-direction side, which is used as the detection electrode 111, is connected to the input terminal 151 by the selector switch 262; and the front-side electrode 110 on the +X-direction side, which is used as the driving electrode 112, is connected to the amplification circuit 140A by the selector switch 261. However, when the selector switches 261 and 262 are operated so that the front-side electrode 110 on the +X-direction side is connected to the input terminal 151 and the front-side electrode 110 on the −X-direction side is connected to the amplification circuit 140A, the front-side electrode 110 on the −X-direction side can be used as the detection electrode 111 and the front-side electrode 110 on the +X-direction side can be used as the driving electrode 112.

When a capacitance (electrostatic capacity) between the detection electrode 111 and the driving electrodes 112 is denoted Cp, equation (2) holds as with the capacitive sensor 100 in embodiment 1. Thus, if the operation decision unit 171 uses an appropriate threshold value for the difference between the output voltages V₀₁ and V₀₂, which are obtained by changing the output of the variable amplification circuit 140C to the alternating-current voltages V_{C} and V_{C2}, to make a decision about whether pressing has been performed, it is possible to remove the effect of the change in the capacitance Cf and to accurately detect that pressing has been performed.

Therefore, it is possible to provide the capacitive sensor 200 that can easily detect that the cover 101 has been pressed with the fingertip FT, as with the capacitive sensor 100 in embodiment 1.

When the variable amplification circuit 140C sets the amplitude of the alternating-current voltage V_{C} to a predetermined amplitude (V_{C1}, for example), the operation decision unit 171 decides that a proximity or contact of the fingertip FT for the cover 101 has been performed, according to the output from the detection unit 150. In addition to pressing, therefore, a proximity and a contact can also be detected. Thus, different functions can be assigned to a contact and pressing so that, for example, when a contact is made, content displayed at the contact position, the content being represented by a GUI or the like, is selected; and when pressing is performed, the selected content is established.

Even when the front-side electrode 110 on the −X-direction side is used as the detection electrode 111 and the front-side electrode 110 on the +X-direction side is used as the driving electrode 112, a proximity of, a contact of, and pressing with the fingertip FT for the detection electrode 111 can be similarly detected according to the output voltage V₀ from the output terminal 155 of detection unit 150.

Thus, when one of the two front-side electrodes 110 is used as the detection electrode 111 and the other is used as the driving electrode 112, a proximity of, a contact of, and pressing with the fingertip FT for the detection electrode 111 can be detected.

The selector switches 261 and 262 included in the capacitive sensor 200 as selection units selectively select the detection electrode 111 from the front-side electrodes 110. The amplification circuit 140B may output the alternating-current voltage V_{B} to the detection electrode 111 selected by the selector switch 261 or 262, whichever is appropriate. Therefore, when the selector switches 261 and 262 are added as a minimal circuit to selectively set each of the two front-side electrodes 110 to the detection electrode 111 or driving electrode 112, a proximity of, a contact of, and pressing with the fingertip FT (detection target) for the cover 101 can be detected according to the output voltage V₀.

An aspect has been described in embodiment 2 in which one of two front-side electrodes 110 is used as the detection electrode 111 and the other is used as the driving electrode 112. However, when, for example, the capacitive sensor 200 includes three front-side electrodes 110 arranged in the X direction, a proximity of, a contact of, and pressing with the fingertip FT for the detection electrode 111 can be detected by connecting three selector switches similar to the selector switches 261 and 262 so that when the front-side electrode 110 on the −X-direction side is to be used as the detection electrode 111, the front-side electrode 110 at the center in the X direction and the front-side electrode 110 on the +X-direction side are selected as the driving electrodes 112. When the front-side electrode 110 on the +X-direction side is to be used as the detection electrode 111, the reverse is applicable.

When the front-side electrode 110 at the center in the X direction is to be used as the detection electrode 111, the front-side electrodes 110 on the −X-direction side and on the +X-direction side are used as the driving electrodes 112 to detect a proximity of, a contact of, and pressing with the fingertip FT for the detection electrode 111. It is also possible to use one of the front-side electrodes 110 other than the detection electrode 111 as the driving electrode 112 and to use the remaining front-side electrodes 110 as floating electrodes.

When four or more front-side electrodes 110 are to be used, a plurality of capacitive sensors 200 illustrated in, for example, FIG. 6 only need to be provided to detect a proximity, a contact, and pressing for the front-side electrode 110 selected as the detection electrode 111.

### Embodiment 3

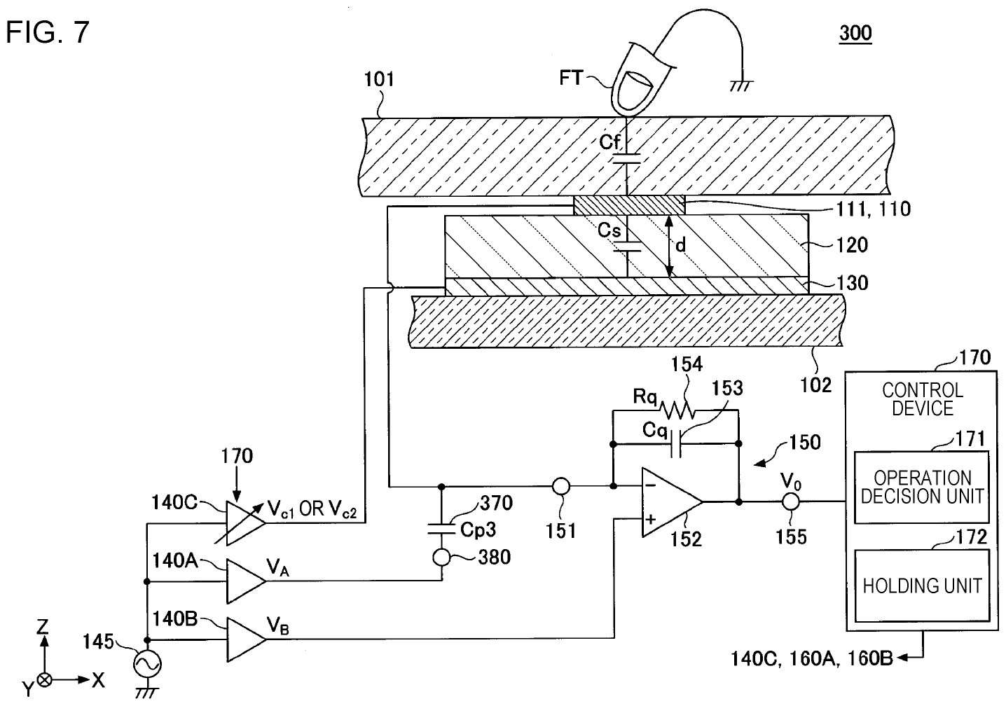

FIG. 7 illustrates a capacitive sensor 300 in embodiment 3. The capacitive sensor 300 includes the cover 101, the substrate 102, the detection electrode 111, the elastic dielectric body 120, the shield electrode 130, the amplification circuit 140A, the amplification circuit 140B, the variable amplification circuit 140C, the power supply circuit 145, the detection unit 150, a capacitor 370, and a terminal 380.

In embodiment 3, an aspect will be described in which the capacitive sensor 300 includes one front-side electrode 110, which is used as the detection electrode 111. Constituent elements similar to those of the capacitive sensor 100 in embodiment 1 will be given identical reference characters and descriptions of these constituent elements will be omitted.

The capacitor 370 is disposed instead of forming the capacitance Cp between the detection electrode 111 and the two driving electrodes 112 in embodiment 1. The capacitor 370 has a capacitance Cp3. The capacitance Cp3 is equal to the capacitance Cp in embodiment 1, as an example.

The terminal 380 is an example of the driving unit. The terminal 380 is connected with the capacitance Cp3 interposed between the terminal 380 and the detection electrode 111. The terminal 380 in this embodiment is a constituent element to which the alternating-current voltage V_{A} is output from the amplification circuit 140A, instead of the two driving electrodes 112 in embodiment 1.

The capacitance Cf between the detection electrode 111 and the fingertip FT and the capacitance Cs between the detection electrode 111 and the shield electrode 130 are respectively similar to the capacitance Cf and capacitance Cs in embodiment 1. Therefore, as in embodiment 1, the output voltage V₀ from the output terminal 155 of detection unit 150 can be represented as in equation (2).

Thus, if the operation decision unit 171 uses an appropriate threshold value for the difference between the output voltages V₀₁ and V₀₂, which are obtained by changing the output of the variable amplification circuit 140C to the alternating-current voltages V_{C1} and V_{C2}, to make a decision about whether pressing has been performed, it is possible to remove the effect of the change in the capacitance Cf and to accurately detect that pressing has been performed.

Therefore, it is possible to provide the capacitive sensor 300 that can easily detect that the cover 101 has been pressed with the fingertip FT, as with the capacitive sensor 100 in embodiment 1.

When the variable amplification circuit 140C sets the amplitude of the alternating-current voltage V_{C} to a predetermined amplitude (V_{C1}, for example), the operation decision unit 171 decides that a proximity or contact of the fingertip FT for the cover 101 has been performed, according to the output from the detection unit 150. In addition to pressing, therefore, a proximity and a contact can also be detected. Thus, different functions can be assigned to a contact and pressing so that, for example, when a contact is made, content displayed at the contact position, the content being represented by a GUI or the like, is selected; and when pressing is performed, the selected content is established.

In embodiment 3, the capacitive sensor 300, in which only one front-side electrode 110 is used, the one front-side electrode 110 being employed as the detection electrode 111, has been described. When a plurality of front-side electrodes 110 are used, a plurality of capacitive sensors 300 illustrated in, for example, FIG. 7 only need to be provided so that each front-side electrode 110 is used as the detection electrode 111 to detect a proximity, a contact, and pressing for the detection electrode 111.

This completes the description of the capacitive sensor in an exemplary embodiment in the present invention. However, the present invention is not limited to specifically disclosed embodiments, but can be varied and modified in various other ways without departing from the scope of the claims.

This international application claims priority based on Japanese Patent Application No. 2021-161423 filed on Sep. 30, 2021, and the entire contents of the application are incorporated in this international application by reference in it.

1. A capacitive sensor for detecting a motion of a detection target, comprising:
an elastic dielectric body having a front surface and a back surface;
at least one front-side electrode provided on the front surface of the elastic dielectric body, the at least one front-side electrode including at least one detection electrode;
a cover placed on a front side of the at least one front-side electrode;
a shield electrode disposed on the back surface of the clastic dielectric body;
a driving unit provided on the front surface of the elastic dielectric body and capacitively coupled to the at least one detection electrode to form a capacitance therebetween;
a first voltage output unit configured to output a first AC voltage to the driving unit;
a second voltage output unit configured to output a second AC voltage to the shield electrode, the second AC voltage having a same frequency and a same phase as the first AC voltage;
a detection unit connected to the at least one detection electrode, configured to detect a capacitance of the at least one front-side electrode and output a detection output corresponding to the detected capacitance; and
an operation decision unit configured to determine a motion of the detection target according to the detection output,
wherein the second voltage output unit is further configured to change an amplitude of the second AC voltage, thereby outputting the second AC voltage with a plurality of amplitudes,
and wherein the operation decision unit is further configured to determine that the detection target has performed a pressing operation with against the cover, based on a plurality of detection outputs corresponding to the plurality of amplitudes of the second AC voltage.

2. The capacitive sensor according to claim 1, further comprising:
a third voltage output unit configured to output a third AC voltage having a same frequency and a same phase as the first AC voltage,
wherein the detection unit includes an operational amplifier comprising:
an output terminal;
an inverting input terminal connected to the at least one detection electrode; and
a non-inverting input terminal connected to the third voltage output unit,
and wherein the operational amplifier performs a negative feedback operation via a capacitor and a resistor.

3. The capacitive sensor according to claim 2,
wherein an output voltage V₀ from the output terminal of the operation amplifier is represented by Equation (1) below, in which Cf denotes a capacitance between the detection electrode and the detection target, Cp denotes the capacitance between the detection electrode and the driving unit, Cs denotes a capacitance between the detection electrode and the shield electrode, V_{A} denotes the first AC voltage V_{C} denotes the second AC voltage V_{B} denotes the third AC voltage, and Cq denotes a capacitance of the capacitor connected between the output terminal and the inverting input terminal of the operational amplifier
V₀=Cf×V_{B}+(V_{B}−V_{A})×Cp+(V_{B}−V_{C})×Cs/Cq (1).

4. The capacitive sensor according to claim 3,
wherein an amplitude of the first AC voltage V_{A}, the amplitude of the second AC voltage V_{C}, and an amplitude of the third AC voltage V_{B} are set such that the term (V_{B}−V_{A})×Cp and the term (V_{B}−V_{C})×Cs in Equation (1) are canceled each other when no pressing operation is performed by the detection target.

5. The capacitive sensor according to claim 2, further comprising:
a selection unit configured to select the at least one detection electrode from among the at least one front-side electrode,
wherein the third voltage output unit is configured to output the third AC voltage to the at least one detection electrode selected by the selection unit.

6. The capacitive sensor according to claim 1,
wherein the operation decision unit is further configured to determine that the detection target has approached or contacted the cover based on the detection output from the detection unit when the second voltage output unit outputs the second AC voltage having a predetermined amplitude.

7. The capacitive sensor according to claim 1, further comprising:
a holding unit configured to hold the plurality of detection outputs output from the detection unit when the second voltage output unit changes the amplitude of the second AC voltage,
wherein the operation decision unit determines the pressing operation of the detection target based on the plurality of detection outputs held in the holding unit.

8. The capacitive sensor according to claim 1,
wherein the at least one detection electrode includes a plurality of detection electrodes, and the at least one front-side electrode includes a plurality of front-side electrodes including the plurality of detection electrodes,
wherein the capacitive sensor further comprises:
a selection unit configured to sequentially select one of the plurality of detection electrodes and connect the selected detection electrode to the detection unit one at a time,
wherein the detection unit is further configured to detect the capacitance of the selected detection electrode, when the second voltage output unit changes the amplitude of the second AC voltage while the selected detection electrode is connected to the detection unit, by outputting a plurality of detection outputs corresponding to the plurality of amplitudes of the second AC voltage,
and wherein the operation decision unit is further configured to determine if the pressing operation has been performed at a position on the cover corresponding to the selected detection electrode based on the plurality of detection outputs.

9. The capacitive sensor according to claim 1,
wherein the at least one front-side electrodes includes a plurality of front-side electrodes,
and wherein the driving unit is at least one of the plurality of front-side electrodes which is not the at least one detection electrode.

10. The capacitive sensor according to claim 9, further comprising:
a first selection unit configured to sequentially select one of the plurality of front-side electrodes as the detection electrode and connect the selected detection electrode to the detection unit; and
a second selection unit configured to select a pair of front-side electrodes adjacent to the selected detection electrode from among the plurality of front-side electrodes as the driving unit and connect the selected driving unit to the first voltage output unit.
